(19) United States
(12) Patent Application Publication
(10) Pub. No.: US 2006/0096723 A1
(43) Pub. Date: May 11, 2006

(54) Magnetically attractable paper structure

(76) Inventor: Hung-Chih Wu, Taipei (TW)

Correspondence Address: BRUCE H. TROXELL, SUITE 1404, 5205 LEESBURG PIKE, FALLS CHURCH, VA, 22041, US

(21) Appl. No.: 10/984,812

(22) Filed: Nov. 10, 2004

(51) Int. Cl. D21H 17/00; G07D 7/00; G06K 9/00

(52) U.S. Cl. 162/138; 194/207

(57) ABSTRACT

A magnetically attractable paper structure including a substrate paper, an interface painting layer and a thin magnetically attractable material painting layer. The interface painting layer is painted on at least one surface of the substrate paper. The magnetically attractable painting layer is painted on an outer face of the interface painting layer. The interface painting layer serves to reduce the humidity absorbability of the substrate paper and enhance the strength thereof as well as prevent the substrate paper from being crimped. Therefore, the magnetically attractable material painting layer can be more easily and firmly bonded with the substrate paper. The magnetically attractable material painting layer is magnetically coordinated and magnetized to have magnetic attraction to form a magnetically attractable paper.

### BACKGROUND OF THE INVENTION

The present invention is related to a magnetically attractable paper structure, and more particularly to a magnetically attractable paper structure which is flexible, light and thin.

It is often seen that a magnet is attracted on an iron-made surface. For example, a magnet can be attracted on a whiteboard or a casing of a refrigerator for fixing a memo or marking a position. The magnet can be a block body or a plate body with a certain thickness. Such magnet is not flexible so that the application of the magnet is quite limited.

FIG. 1 shows magnetic structure including a substrate 10 and a magnetic sheet 30 adhered to one face of the substrate 10. The substrate 10 can be rigid or flexible and made with a predetermined shape. The magnetic sheet can be mainly made of barium, strontium, rubidium, cobalt or boron. The magnetic sheet 30 is magnetically coordinated and magnetized, whereby the substrate 10 has magnetic at tract ion.

A common paper sheet is required to have thin thickness, good flexibility, high humidity absorbability and breakability. In the case that the magnetic sheet 30 is directly adhered to or overlaid on the surface of the paper sheet, the thickness and flexibility of the paper sheet will be greatly affected. This will limit the application of the paper sheet.

Moreover, it is known that paper sheet will quickly absorb liquid into the fibers to crimp the paper. In the case that a magnetic solution is painted on the surface of the paper, the solvent of the solution will be fully absorbed into the paper. Therefore, even in a dry state, the magnetic material can be hardly truly bonded with the surface of the paper. As a result, the magnetic material tends to detach from the paper.

Also, a magnetic material can be added to a fabric in such a manner that the fabric is directly soaked into a magnetically attractable material (magnetic powder or ferrous material powder) doped with spreading agent. After the magnetically attractable material infiltrates into the fibers of the fabric, the fabric is rolled to remove excessive magnetically attractable material and pressed into a thin sheet. The thin sheet is then magnetized as necessary to form a magnetically attractable fabric product. However, such processing measure is not applicable to paper material which has high water absorbability.

### SUMMARY OF THE INVENTION

It is therefore a primary object of the present invention to provide a magnetically attractable paper structure including a substrate paper. An interface painting layer is painted on at least one surface of the substrate paper. A liquid magnetically attractable material is then painted on an outer face of the interface painting layer to form a thin magnetically attractable material painting layer. The interface painting layer serves as a protective film for reducing the solvent absorbability of the substrate paper. Therefore, the magnetically attractable material painting layer can be more easily and firmly bonded with the substrate paper. The magnetically attractable material painting layer is magnetically coordinated and magnetized to have magnetic attraction to form a magnetically attractable paper with very thin thickness and good flexibility.

It is a further object of the present invention to provide the above magnetically attractable paper structure in which the interface painting layer also serves to enhance the strength of the substrate paper and prevent the substrate paper from being crimped.

The present invention can be best understood through the following description and accompanying drawings wherein:

### BRIEF DESCRIPTION OF THE DRAWINGS

FIG. 1 is a sectional view of a conventional magnetic sheet;

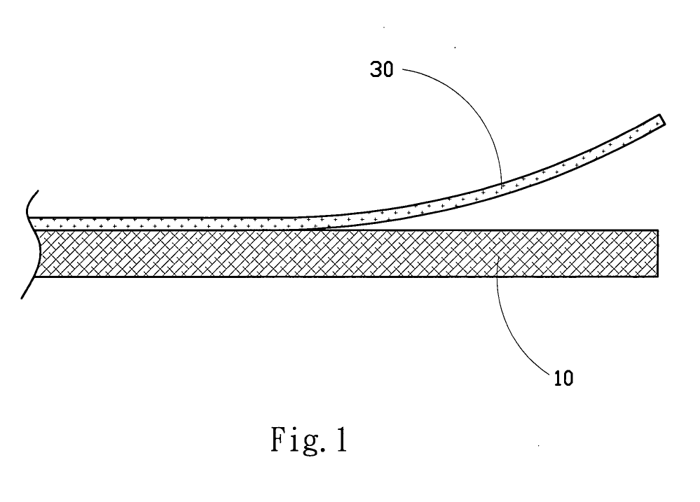

FIG. 2 is a perspective view of the magnetically attractable paper of the present invention; and

FIG. 2-1 is a sectional view of the magnetically attractable paper of the present invention.

### DETAILED DESCRIPTION OF THE PREFERRED EMBODIMENTS

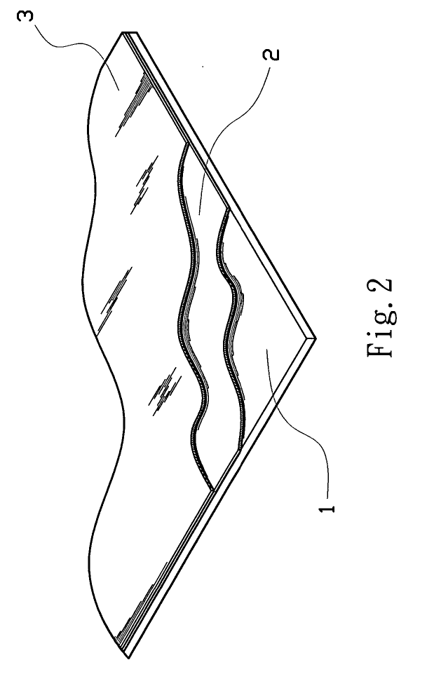

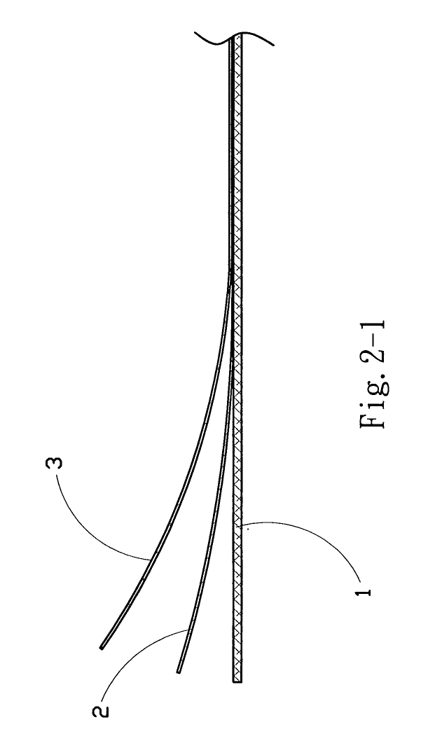

Please refer to FIG. 2. The present invention includes a substrate paper 1, an interface painting layer 2 and a magnetically attractable material painting layer 3 (such as magnetic powder solution or ferrous material solution). The interface painting layer 2 is a waterproof material such as PVA, UV or polymolecular painting. The interface painting 2 is disposed on at least one surface of the substrate paper 1 by means of painting, coating or rolling pressing for reducing the humidity absorbability of the substrate paper 1 and enhancing the strength thereof. The magnetically attractable painting is made of magnetic material such as barium, strontium, rubidium, cobalt or boron or ferrous material doped with spreading agent (such as antifoamer, anti-sedimentation agent, gelatinizer, wetting agent and color-spreading agent). The magnetically attractable painting is painted on the surface of the interface painting layer 2 to form the magnetically attractable material painting layer 3. The spreading agent of the magnetically attractable material painting layer 3 is not absorbed by the substrate paper 1 so that the magnetically attractable material painting layer 3 can be more easily and firmly bonded with the substrate paper 1. Also, the substrate paper 1 will not be crimped. According to the characteristics of the material and as necessary, the magnetically attractable material painting layer 3 is magnetically coordinated and magnetized to have magnetic attraction. At this time, the magnetically attractable paper is completed.

In the above structure, the substrate paper 1 itself is light and thin and the magnetically attractable material painting layer 3 on outer face of the substrate paper 1 is very thin. Therefore, the consumption of material is reduced and the paper product has the original flexibility and can be easily rolled, folded and cut into a desired shape. Also, the surface of the paper product can be printed with desired pictures and characters. The application of the paper product is widened.

The above embodiments are only used to illustrate the present invention, not intended to limit the scope thereof. Many modifications of the above embodiments can be made without departing from the spirit of the present invention.

What is claimed is:

1. A magnetically attractable paper structure comprising:
a substrate paper;
at least one interface painting layer disposed on at least one surface of the substrate paper; and
at least one magnetically attractable painting layer formed of magnetically attractable material painted on an outer face of the interface painting layer.

2. The magnetically attractable paper structure as claimed in claim 1, wherein the magnetically attractable material is composed of at least one of barium, strontium, rubidium, cobalt and boron, after disposed on the substrate paper, the magnetically attractable material painting layer being magnetically coordinated and magnetized to have magnetic attraction.

3. The magnetically attractable paper structure as claimed in claim 1, wherein the magnetically attractable material is made of ferrous material which is magnetically attractable.

4. The magnetically attractable paper structure as claimed in claim 1, wherein the magnetically attractable painting layer is formed of magnetically attractable material doped with spreading agent.

5. The magnetically attractable paper structure as claimed in claim 2, wherein the magnetically attractable painting layer is formed of magnetically attractable material doped with spreading agent.

6. The magnetically attractable paper structure as claimed in claim 3, wherein the magnetically attractable painting layer is formed of magnetically attractable material doped with spreading agent.

7. The magnetically attractable paper structure as claimed in claim 1, wherein the interface painting layer is made of waterproof material such as PVA, UV or polymolecular painting which is painted on the surface of the substrate paper.

8. The magnetically attractable paper structure as claimed in claim 2, wherein the interface painting layer is made of waterproof material such as PVA, UV or polymolecular painting which is painted on the surface of the substrate paper.

9. The magnetically attractable paper structure as claimed in claim 3, wherein the interface painting layer is made of waterproof material such as PVA, UV or polymolecular painting which is painted on the surface of the substrate paper.

10. The magnetically attractable paper structure as claimed in claim 4, wherein the interface painting layer is made of waterproof material such as PVA, UV or polymolecular painting which is painted on the surface of the substrate paper.

11. The magnetically attractable paper structure as claimed in claim 5, wherein the interface painting layer is made of waterproof material such as PVA, UV or polymolecular painting which is painted on the surface of the substrate paper.

12. The magnetically attractable paper structure as claimed in claim 6, wherein the interface painting layer is made of waterproof material such as PVA, UV or polymolecular painting which is painted on the surface of the substrate paper.

13. The magnetically attractable paper structure as claimed in claim 4, wherein the spreading agent is composed of at least one of antifoamer, anti-sedimentation agent, gelatinizer, wetting agent and color-spreading agent.

14. The magnetically attractable paper structure as claimed in claim 5, wherein the spreading agent is composed of at least one of antifoamer, anti-sedimentation agent, gelatinizer, wetting agent and color-spreading agent.

15. The magnetically attractable paper structure as claimed in claim 6, wherein the spreading agent is composed of at least one of antifoamer, anti-sedimentation agent, gelatinizer, wetting agent and color-spreading agent.

16. The magnetically attractable paper structure as claimed in claim 7, wherein the spreading agent is composed of at least one of antifoamer, anti-sedimentation agent, gelatinizer, wetting agent and color-spreading agent.

17. The magnetically attractable paper structure as claimed in claim 8, wherein the spreading agent is composed of at least one of antifoamer, anti-sedimentation agent, gelatinizer, wetting agent and color-spreading agent.

18. The magnetically attractable paper structure as claimed in claim 9, wherein the spreading agent is composed of at least one of antifoamer, anti-sedimentation agent, gelatinizer, wetting agent and color-spreading agent.

19. The magnetically attractable paper structure as claimed in claim 10, wherein the spreading agent is composed of at least one of antifoamer, anti-sedimentation agent, gelatinizer, wetting agent and color-spreading agent.

20. The magnetically attractable paper structure as claimed in claim 11, wherein the spreading agent is composed of at least one of antifoamer, anti-sedimentation agent, gelatinizer, wetting agent and color-spreading agent.

21. The magnetically attractable paper structure as claimed in claim 12, wherein the spreading agent is composed of at least one of antifoamer, anti-sedimentation agent, gelatinizer, wetting agent and color-spreading agent.
